(19) United States
(12) Patent Application Publication
(10) Pub. No.: US 2018/0247576 A1
(43) Pub. Date: Aug. 30, 2018

(54) AUTOMATIC RECOGNITION METHOD AND APPARATUS FOR COMPATIBILITY BETWEEN SYSTEM AND DISPLAY PANEL

(71) Applicant: Shenzhen China Star Optoelectronics Technology Co., Ltd., Shenzhen, Guangdong (CN)

(72) Inventor: Xiaoyu HUANG, Shenzhen (CN)

(73) Assignee: Shenzhen China Star Optoelectronics Technology Co., Ltd., Shenzhen, Guangdong (CN)

(21) Appl. No.: 15/324,936

(22) PCT Filed: May 12, 2016
(86) PCT No.: PCT/CN2016/108533

§ 371 Date: Jan. 9, 2017

(30) Foreign Application Priority Data
Aug. 31, 2016 (CN) 201610791056.2

(51) Int. Cl. G09G 3/00; H04N 5/50

(52) U.S. Cl. CPC G09G 3/006; G09G 2330/02; H04N 5/50

(57) ABSTRACT

Disclosed is an automatic recognition method and an apparatus for compatibility between a system and a display panel, and the automatic recognition method includes determining a type of the display panel according to a state change of a first voltage signal and a second voltage signal obtained by continuously detecting the display panel, and adjusting the system so as to enable the system and the display panel to be compatible. The automatic recognition method and apparatus resolve a problem that an error easily occurs when the system and the display panel are matched based on a part number manner, and meanwhile, reduces costs of matching management.

### CROSS-REFERENCE TO RELATED APPLICATIONS

The present application claims the priority of Chinese patent application CN 201610791056.2, entitled “Automatic recognition method and apparatus for compatibility between system and display panel” and filed on Aug. 31, 2016, the entirety of which is incorporated herein by reference.

### FIELD OF THE INVENTION

The present disclosure relates to the field of liquid crystal display technologies, and in particular, to an automatic recognition method and an apparatus for compatibility between a system and a display panel.

### BACKGROUND OF THE INVENTION

A thin film transistor liquid crystal display (TFT LCD) is one of main kinds of current panel displays, and has become an important display platform in modern IT and video products.

A main drive principle of the TFT LCD is that a system main board connects an R/G/B compression signal, a control signal, and a motor by means of a cable and a connector on a PCB board. After being processed by a timing controller (Timing Controller, TCON) on the PCB board, data is connected to a display area on a display panel by means of the PCB board, a source drive circuit (Source-Chip on Film, S-COF) and a gate drive circuit (Gate-Chip on Film, G-COF), so as to enable an LCD to obtain a required power source and signal, as shown in FIG. 1.

Because of different properties such as optical performances of display panels provided by different providers, different panels manufactured by different providers correspond to different system parameters in specific use. The system needs to be adjusted according to different display panels, that is, the system has different settings when provided with different display panels. If it cannot be correctly recognized which provider manufactures a particular display panel, system parameters might not be matched with the panels, so as to add processing time and add work load.

An existing method is mainly to manage and control different system settings by means of a part number, which is of high management costs, and is easy to have matching errors. The present disclosure provides solutions to the foregoing problems.

### SUMMARY OF THE INVENTION

One of the technical problems to be solved by the present disclosure is to provide a low-cost and high-precision method for matching a system and a display panel.

To solve the foregoing technical problem, in an embodiment of the present disclosure, an automatic recognition method for compatibility between a system and a display panel is first provided, including the steps of: continuously detecting a first voltage signal and a second voltage signal that are output by the display panel; determining a recognition range of the second voltage signal according to a state change of the first voltage signal; detecting a state change of the second voltage signal in the recognition range; and obtaining a type of the display panel according to a detection result of the second voltage signal, and adjusting the system according to the type of the display panel so as to enable the system and the display panel to be compatible.

Preferably, determining a recognition range of the second voltage signal according to a state change of the first voltage signal includes: determining a first state change of the first voltage signal as a start point of the recognition range of the second voltage signal; and determining a second state change of the first voltage signal as an end point of the recognition range of the second voltage signal.

Preferably, detecting a state change of the second voltage signal in the recognition range includes: after obtaining the start point of the recognition range of the second voltage signal, starting counting the state change of the second voltage signal, and adding 1 to a counting value when the state change occurs once in the second voltage signal; after obtaining the end point of the recognition range of the second voltage signal, stopping counting, and using the counting value as a detection result.

Preferably, the state change includes a rising edge and a falling edge when a signal has a voltage jump.

Preferably, the state change includes a positive pulse or a negative pulse when a signal has a voltage jump.

Preferably, adjusting the system according to a type of the display panel so as to enable the system and the display panel to be compatible includes adjusting setting of optical property parameters of the system.

In an embodiment of the present disclosure, an automatic recognition apparatus is further provided for compatibility between a system and a display panel, including: a detection module, which continuously detects a first voltage signal and a second voltage signal that are output by the display panel; a recognition range determining module, which determines a recognition range of the second voltage signal according to a state change of the first voltage signal; a recognition module, which detects a state change of the second voltage signal in the recognition range; and an adjustment module, which obtains a type of the display panel according to a detection result of the second voltage signal, and adjusts the system according to the type of the display panel so as to enable the system and the display panel to be compatible.

Preferably, the recognition range determining module determines a first state change of the first voltage signal as a start point of the recognition range of the second voltage signal; and determines a second state change of the first voltage signal as an end point of the recognition range of the second voltage signal.

Preferably, the recognition module starts counting the state change of the second voltage signal after obtaining the start point of the recognition range of the second voltage signal, and adds 1 to a counting value when the state change occurs once in the second voltage signal; and after obtaining the end point of the recognition range of the second voltage signal, the recognition module stops counting, and uses the counting value as a detection result.

Preferably, the adjustment module adjusts setting of optical property parameters of the system.

Compared with the prior art, one or more embodiments of the present disclosure may have the following advantages or beneficial effects.

Recognition is performed on the first voltage signal and the second voltage signal generated by the display panel so as to determine the type of the display panel, thereby resolving a problem that an error easily occurs when the system and the display panel are matched based on a part number manner in the prior art, and meanwhile, reducing costs of matching management.

Other advantages, objectives, and features of the present disclosure will be further explained in the following description in a certain degree, and in some degree, are obvious to those skilled in the art based on observation and research of the following text or can be taught from practices of the present disclosure. The objectives and other advantages of the present disclosure can be implemented and obtained by means of the structures specifically pointed out in the following description, claims, and accompany drawings.

### BRIEF DESCRIPTION OF THE DRAWINGS

The drawings are provided for further understanding of the technical solutions of the present application or the prior art, and constitute one part of the description. The drawings expressing the embodiments of the present application serve to explain the technical solutions of the present application in conjunction with the embodiments of the present application, rather than to limit the technical solutions of the present application in any manner. In the drawings:

FIG. 1 is a drive architecture diagram of a thin film transistor liquid crystal display in the prior art;

FIG. 2 is a flowchart of an automatic recognition method for compatibility between a system and a display panel according to an embodiment of the present disclosure;

FIG. 3 is a structural diagram of a signal generation circuit used for generating a first voltage signal and a second voltage signal according to another embodiment of the present disclosure;

FIG. 4 is a diagram of a detection waveform of the signal generation circuit shown in FIG. 3; and

FIG. 5 is a structural diagram of an automatic recognition apparatus for compatibility between a system and a display panel according to another embodiment of the present disclosure.

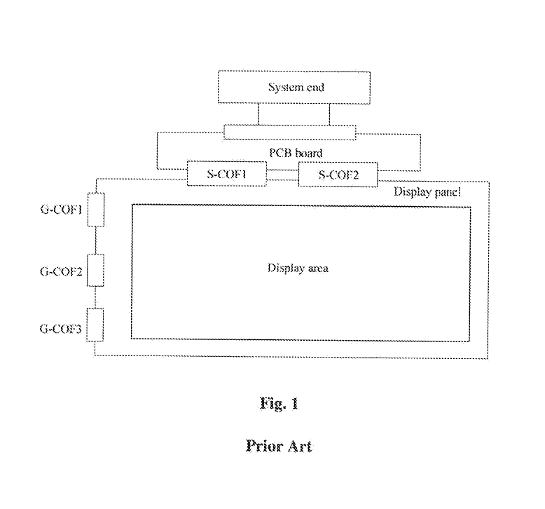

### DETAILED DESCRIPTION OF THE EMBODIMENTS

The following describes implementation manners of the present disclosure in detail by combining the accompanying drawings and embodiments, so as to fully understand an implementation process of how the present disclosure applies the technical means and resolves the technical problems, and to implement the present disclosure accordingly. The embodiments of the present application and features in the embodiments may be combined with each other without conflicting with each other, and the formed technical solutions are within the scope of the present disclosure.

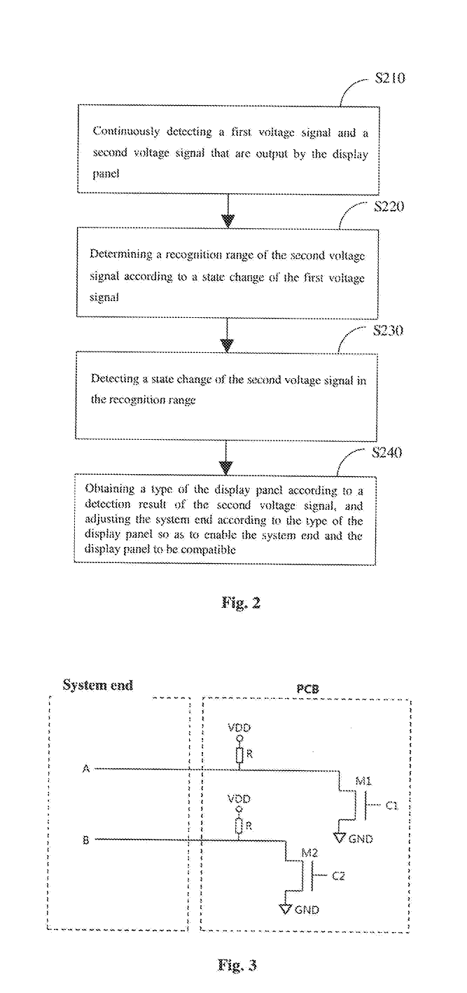

FIG. 2 is a flowchart of an automatic recognition method for compatibility between a system and a display panel according to an embodiment of the present disclosure. As shown in FIG. 2, the method includes the following steps.

In step S210, a first voltage signal and a second voltage signal that are output by the display panel are continuously detected.

In step S220, a recognition range of the second voltage signal is determined according to a state change of the first voltage signal.

In step S230, a state change of the second voltage signal is detected in the recognition range.

In step S240, a type of the display panel is obtained according to a detection result of the second voltage signal, and the system according to the type of the display panel is adjusted so as to enable the system and the display panel to be compatible.

Specifically, in step S210, a signal generation circuit is disposed on the display panel. After a liquid crystal display device is power on, the system of the liquid crystal display device continuously obtains the first voltage signal and the second voltage signal that are output by the signal generation circuit.

In step S220, the recognition range of the second voltage signal is determined by judging the state change of the first voltage signal. In this embodiment of the present disclosure, the first voltage signal and the second voltage signal are in two-value states, that is, the first voltage signal and the second voltage signal respectively define two states.

A high voltage (such as 3.3V) of the first voltage signal and the second voltage signal is defined as a signal state, and a low voltage (such as 0V) of the first voltage signal and the second voltage signal as another signal state. Therefore, on one aspect, the state change in this embodiment of the present disclosure refers to a rising edge when the low voltage jumps to be the high voltage, or a falling edge when the high voltage jumps to be the low voltage. During actual detection, an edge trigger may be used to obtain a signal.

In another aspect, the state change in this embodiment of the present disclosure further refers to a negative pulse when a stable state of the signal is in a high voltage and there is a voltage jump, or a positive pulse when a stable state of the signal is in a low voltage and there is a voltage jump. During actual detection, a level trigger may be used to obtain a signal.

When it is detected that the first voltage signal has a first state change, it is determined as a start point of the recognition range of the second voltage signal, and a start signal may be generated and output. When it is detected that the first voltage signal has a second state change, it is determined as an end point of the recognition range of the second voltage signal, and an end signal may be generated and output.

Subsequently, in step S230, the state change of the second voltage signal is detected in a recognition range defined by the start signal and the end signal.

In one embodiment of the present disclosure, after the start signal is received, counting of the state change of the second voltage signal is started. Specifically, a counter can be used to count the second voltage signal. A counting value of the counter is added with each time the second voltage signal has a state change. After the end signal is received, the counting is stopped, and the counting value is used as a detection result of the second voltage signal.

Finally, in step S240, which provider provides the panel is determined by means of the counting value. Parameters are separately set for panels of different factories. Step S240 includes adjusting settings of optical property parameters of the system so as to enable the system and the display panel to be compatible.

In the automatic recognition method of this embodiment of the present disclosure, the system detects and recognizes the first voltage signal and the second voltage signal that are output by the display panel so as to obtain type information of the display panel, and further adjusts parameters according to the type information of the display panel, so as to achieve automatic recognition and compatibility between the system and the display panel, and reduce additional time and costs caused by error matching.

In another embodiment of the present disclosure, a signal generation circuit used for generating a first voltage signal and a second voltage signal is provided, and a structural diagram thereof is shown in FIG. 3.

The signal generation circuit is composed of thin film transistors M1 and M2 and two resistors with a resistance value R, wherein the thin film transistor M1 has a grid end receiving a signal C1, a source connected to a signal ground GND, and a drain connected to a high voltage VDD by means of the resistor R. The drain of M1 outputs a signal A as the second voltage signal. The thin film transistor M2 has a grid end receiving a signal C2, a source connected to a signal ground GND, and a drain connected to a high voltage VDD by means of the resistor R. The drain of M2 outputs a signal B as the first voltage signal.

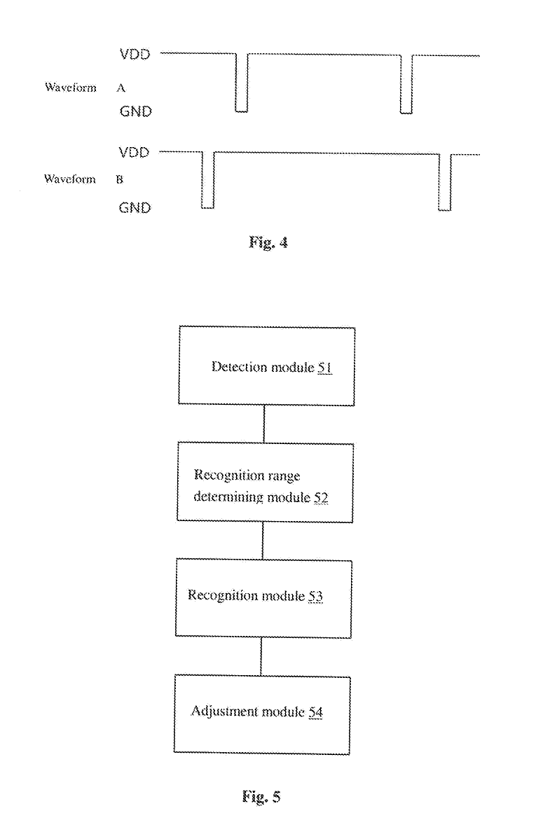

The high voltage of the detection ends A and B correspond to the VDD in FIG. 3, and is generally 3.3 V. The low voltage corresponds to the GND in FIG. 3, and is generally 0 V. When the grid of M1 is a high level, M1 is open, and the detection end A outputs a low level. When the grid of M1 is a low level, M1 is closed, and the detection end A outputs a high level. When the grid of M2 is a low level, M2 is closed, and the detection end B outputs a high level. When the grid of M2 is a high level, M2 is open, and the detection end B outputs a low level. Waveforms of A and B are shown in FIG. 4.

When a negative pulse (that is, a low level signal) of the end B is detected, detection of the end A is started, and each time when the end A detects that the voltage is a negative pulse (that is, a low level signal), a counting value is added with 1. When a negative pulse (that is, a low level signal) appears at the end B for a second time, counting is stopped and detection of the end A is stopped, so as to obtain a final counting value.

Signals C1 and C2 are used for setting according to the type of the display panel. As shown in FIG. 4, in a recognition range determined by two negative pulse signals of the end B, two negative pulses are detected at the end A, that is, the counting value is 2. A corresponding number-2 panel provider can be obtained by searching a table. The system parameters are adjusted so as to enable the adjusted system parameters to be adapted to properties of the panel.

In another embodiment of the present disclosure, an automatic recognition method for compatibility between a system and a display panel is provided. The structure of the apparatus is as shown in FIG. 5, including the following modules.

A detection module 51 continuously detects a first voltage signal and a second voltage signal that are output by the display panel.

A recognition range determining module 52 determines a recognition range of the second voltage signal according to a state change of the first voltage signal.

A recognition module 53 detects a state change of the second voltage signal in the recognition range.

An adjustment module 54 obtains a type of the display panel according to a detection result of the second voltage signal, and adjusts the system according to the type of the display panel so as to enable the system and the display panel to be compatible.

Specific functions of the above modules can be obtained according corresponding steps of the method of a former embodiment, and details are not described herein again.

The embodiment of the present disclosure is applied to automatic recognition and matching of a source of a liquid crystal display panel, so as to save management and control costs and adjust matching efficiency and matching exactness.

The above description should not be construed as limitations of the present disclosure, but merely as exemplifications of preferred embodiments thereof to facilitate understanding of the present disclosure. Any variations or replacements in implementation forms and details that can be readily envisioned by those skilled in the art, without departing from the scope and the range disclosed in the present disclosure, are intended to be within the scope of the present disclosure. However, the patent scope of the present disclosure should be subject to the scope defined in the attached claims.

1. An automatic recognition method for compatibility between a system and a display panel, comprising:
continuously detecting a first voltage signal and a second voltage signal that are output by the display panel;
determining a recognition range of the second voltage signal according to a state change of the first voltage signal;
detecting a state change of the second voltage signal in the recognition range; and
obtaining a type of the display panel according to a detection result of the second voltage signal, and adjusting the system according to the type of the display panel so as to enable the system and the display panel to be compatible.

2. The method according to claim 1, wherein determining a recognition range of the second voltage signal according to a state change of the first voltage signal comprises:
determining a first state change of the first voltage signal as a start point of the recognition range of the second voltage signal; and
determining a second state change of the first voltage signal as an end point of the recognition range of the second voltage signal.

3. The method according to claim 2, wherein detecting a state change of the second voltage signal in the recognition range comprises:
after obtaining the start point of the recognition range of the second voltage signal, starting counting the state change of the second voltage signal, and adding 1 to a counting value when the state change occurs once in the second voltage signal; and
after obtaining the end point of the recognition range of the second voltage signal, stopping counting, and using the counting value as a detection result.

4. The method according to claim 1, wherein the state change includes a rising edge or a falling edge when a signal has a voltage jump.

5. The method according to claim 1, wherein the state change includes a positive pulse or a negative pulse when a signal has a voltage jump.

6. The method according to claim 4, wherein adjusting the system according to a type of the display panel so as to enable the system and the display panel to be compatible includes adjusting setting of optical property parameters of the system.

7. An automatic recognition apparatus for compatibility between a system and a display panel, comprising:
a detection module, continuously detecting a first voltage signal and a second voltage signal that are output by the display panel;
a recognition range determining module, determining a recognition range of the second voltage signal according to a state change of the first voltage signal;
a recognition module, detecting a state change of the second voltage signal in the recognition range; and
an adjustment module, obtaining a type of the display panel according to a detection result of the second voltage signal, and adjusting the system according to the type of the display panel so as to enable the system and the display panel to be compatible.

8. The apparatus according to claim 7, wherein the recognition range determining module determines a first state change of the first voltage signal as a start point of the recognition range of the second voltage signal, and determines a second state change of the first voltage signal as an end point of the recognition range of the second voltage signal.

9. The apparatus according to claim 8, wherein the recognition module starts counting the state change of the second voltage signal after obtaining the start point of the recognition range of the second voltage signal, and adds 1 to a counting value when the state change occurs once in the second voltage signal; and
wherein the recognition module stops counting after obtaining the end point of the recognition range of the second voltage signal, and uses the counting value as a detection result.

10. The apparatus according to claim 9, wherein the adjustment module adjusts setting of optical property parameters of the system.

11. A signal generation circuit, wherein the signal generation circuit is disposed on a display panel and configured to generate a first voltage signal and a second voltage signal, and the signal generation circuit includes a first thin film transistor, a first resistor, a second thin film transistor, and a second resistor.
wherein the first thin film transistor has a grid connected to a first input signal, a drain connected to a high level signal by means of the first resistor, and a source connected to a signal ground, a first voltage signal being generated and output at a connection node of the drain and the first resistor; and
wherein the second thin film transistor has a grid connected to a second input signal, a drain connected to a high level signal by means of the second resistor, and a source connected to a signal ground, a second voltage signal being generated and output at a connection node of the drain and the second resistor.

12. The signal generation circuit according to claim 1, wherein the first input signal and the second input signal are set according to a type of the display panel.
